(19) United States
(12) Patent Application Publication
(10) Pub. No.: US 2024/0205859 A1
(43) Pub. Date: Jun. 20, 2024

(54) SYSTEMS AND METHODS FOR SESSION SETUP OR REGISTRATION IN A CORE NETWORK

(71) Applicant: Verizon Patent and Licensing Inc., Basking Ridge, NJ (US)

(72) Inventors: Barry F. HOFFNER, Bridgewater, NJ (US); James MATHISON, Greer, SC (US); Lixia YAN, Basking Ridge, NJ (US)

(73) Assignee: Verizon Patent and Licensing Inc., Basking Ridge, NJ (US)

(21) Appl. No.: 18/066,597

(22) Filed: Dec. 15, 2022

(51) Int. Cl. H04W 60/00; H04W 8/20

(52) U.S. Cl. CPC H04W 60/00; H04W 8/20

(57) ABSTRACT

In some implementations, a first network function device may transmit a request for discovery of a unified data management (UDM) device included in the core network. The first network function device may receive, based on the request, an indication of a UDM group identifier associated with the UDM device and a user data repository (UDR) group identifier associated with a UDR device that is associated with the UDM device. The first network function device may transmit, to one or more second network function devices included in the core network, an indication of at least one of the UDM group identifier or the UDR group identifier.

### BACKGROUND

In a fifth generation (5G) core network, a network function device in the core network may discover and obtain user data from other network function devices, such as a user data repository (UDR) device and/or a unified data management (UDM) device in order to establish a session for a user device. The user data may include information such as which services are enabled for the user device, what the subscriptions of the user device are, and/or other user data.

### BRIEF DESCRIPTION OF THE DRAWINGS

FIGS. 1A-1E are diagrams of an example associated with session setup or registration in a core network.

FIGS. 2A-2C are diagrams of an example associated with session setup or registration in a core network.

FIG. 3 is a diagram of an example environment in which systems and/or methods described herein may be implemented.

FIG. 4 is a diagram of example components of a device associated with session setup or registration in a core network.

FIG. 5 is a flowchart of an example process associated with session setup or registration in a core network.

### DETAILED DESCRIPTION OF EXAMPLE EMBODIMENTS

The following detailed description of example implementations refers to the accompanying drawings. The same reference numbers in different drawings may identify the same or similar elements.

In a session setup procedure and/or in a registration procedure for a user device, a network function in a core network (e.g., a fifth generation (5G) core network or another generation of core network) may query a network repository function (NRF) device to discover other network functions in the core network. The other network functions may include a user data repository (UDR) device and/or a unified data management (UDM) device to which the user device is assigned. The core network may include many UDR device and UDM device groups. Each group may include one or more UDR devices and one or more UDM devices that maintain data for a subset of subscribers of a wireless network (e.g., a 5G wireless network or another type of wireless network). Each user device associated with a subscriber may be assigned to only one of the UDR device and one UDM device groups at a time. The NRF device performs a lookup to identify the UDR device and UDM device group, associated with a subscriber, based on an identifier (e.g., a subscription permanent identifier (SUPI) or another type of identifier) associated with a user profile that is assigned to the subscriber. This lookup may be referred to as a SUPI-based lookup.

A core network may include many network function devices that query the NRF device to discover the UDM device and the UDR device during a session setup procedure or during a registration procedure for the user device. Thus, the NRF device performs many identifier-based lookups, for each of the network function devices, to identify one or more UDR devices and one or more UDM devices to which the user device is assigned. The high quantity of these identifier-based lookups results in greatly increased session setup latency and/or increased 5G registration latency for the user device, which may result in increased session setup times and/or increased registration times for the user device. As an example, the session setup latency and/or increased 5G registration latency may increase as each additional network function device queries the NRF devices (e.g., five additional network function devices querying the NRF device during a session setup procedure or during a registration procedure may result in approximately a 500% increase in latency). Moreover, the increased session setup latency and/or increased 5G registration latency may result in an increased likelihood of a session setup timeout or a registration timeout, which may result in a fallback to a fallback core network (e.g., a Long Term Evolution (LTE) core network) and reduced transfer speeds and reduced quality of service (QOS) for the user device.

Some implementations described herein provide systems and methods for session setup or registration in a core network. In a session setup procedure and/or in a registration procedure for a user device, only a first network function device in a core network performs a SUPI-based lookup with the NRF device to discover one or more UDR devices and one or more UDM devices to which the user device is assigned. The NRF device provides, to the first network function device, information associated with the one or more UDR devices and the one or more UDM devices to which the user device is assigned. The information may include identifiers associated with the one or more UDR devices and the one or more UDM devices. The one or more UDR devices and the one or more UDM devices may be included in the same UDR device and UDM device group.

Instead of other network functions in the core network performing similar operations with the NRF device to discover the UDR device(s) and the UDM device(s), the first network function provides the identifiers associated with the UDR device(s) and the UDM device(s) to the other network function devices. In this way, the other network functions do not repeat the SUPI-based lookup with the NRF device, and instead can proceed directly with requesting user data, associated with the user device, from the UDR device(s) and/or the UDM device(s) using the appropriate identifier provided by the first network function.

In this way, the quantity of identifier-based lookups with the NRF device during a session setup procedure and/or during a registration procedure for the user device is reduced, which greatly reduces latency in a session setup procedure and/or in a registration procedure. In particular, the amount of latency reduction is directly dependent upon the quantity of network function devices that would otherwise repeat the SUPI-based lookup that is performed by the first network function device. For example, if only one network function device performs a SUPI-based lookup instead of six network function devices, the latency reduction based on the techniques described herein may be approximately 83%. Accordingly, the session setup procedures and/or the registration procedures described herein may reduce session setup times and/or registration times for a user device, and may reduce the likelihood of a session setup timeout and/or a registration timeout occurring, which might otherwise result in a fallback to an LTE core network.

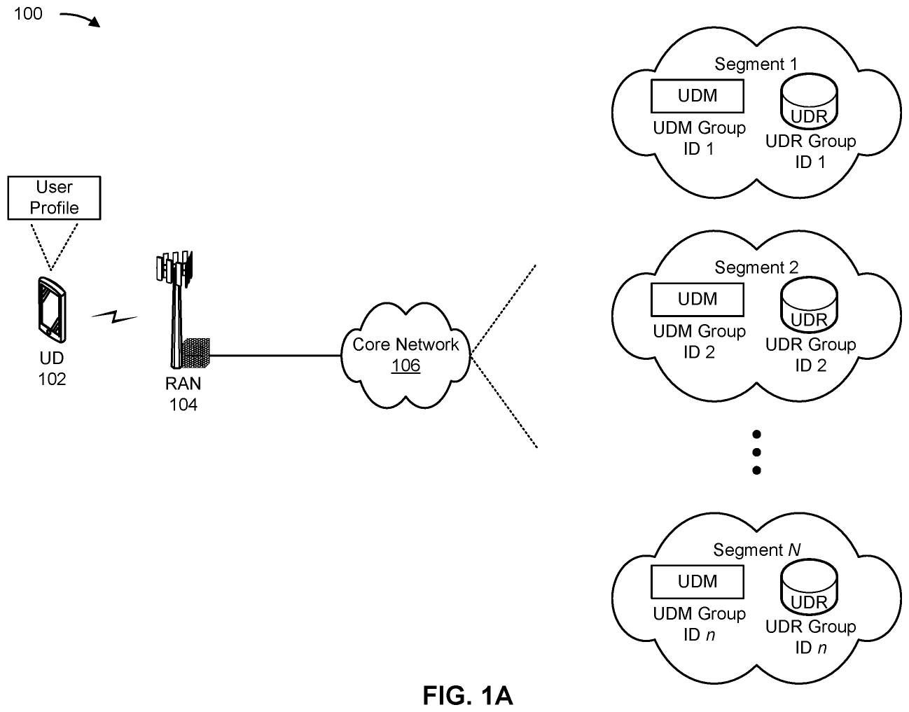

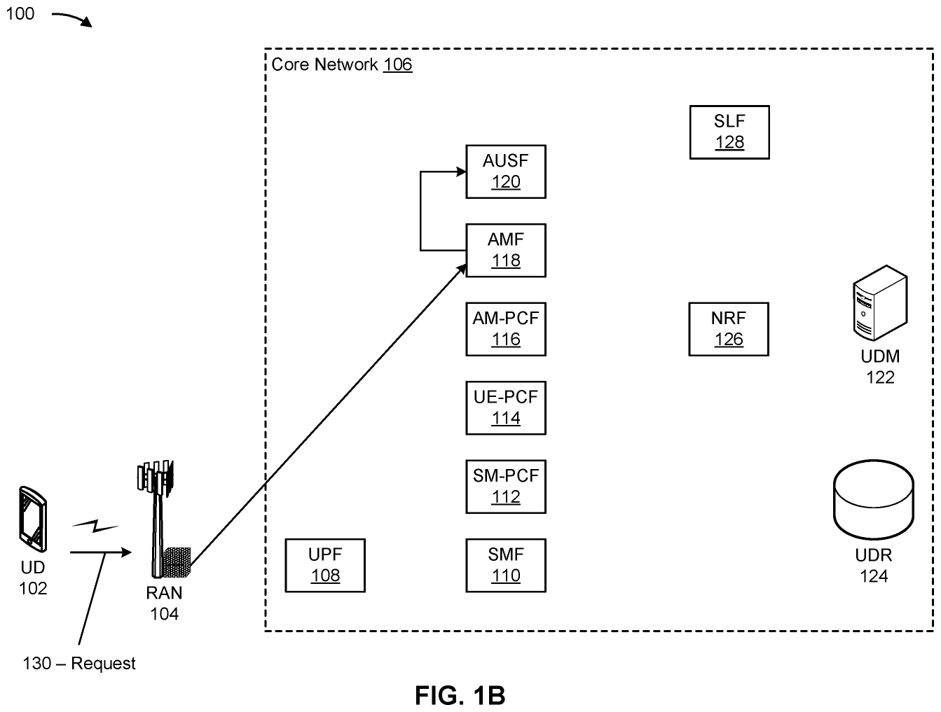

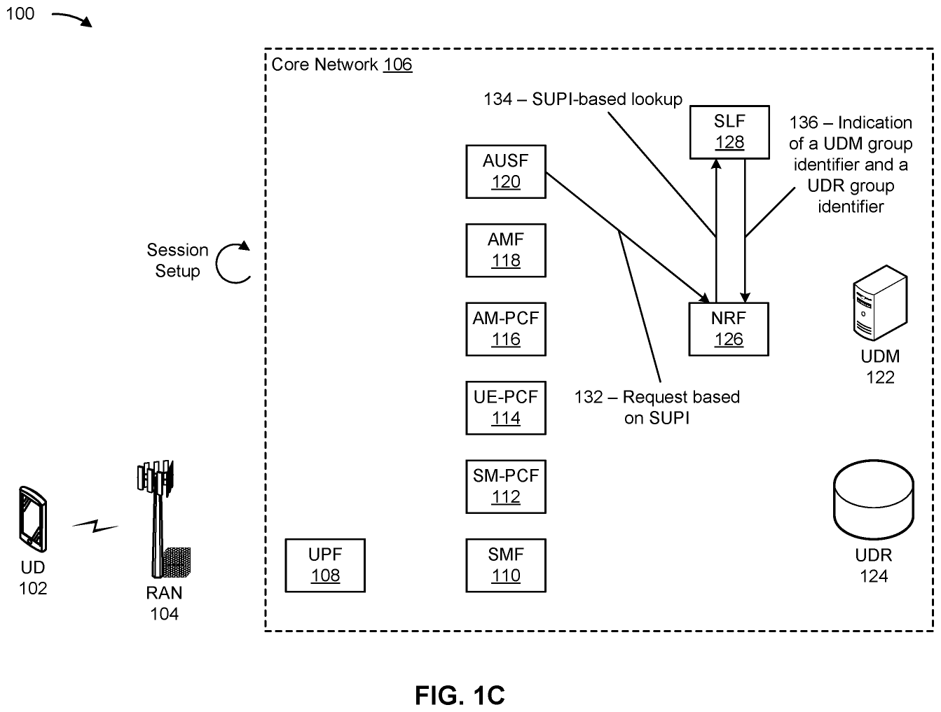

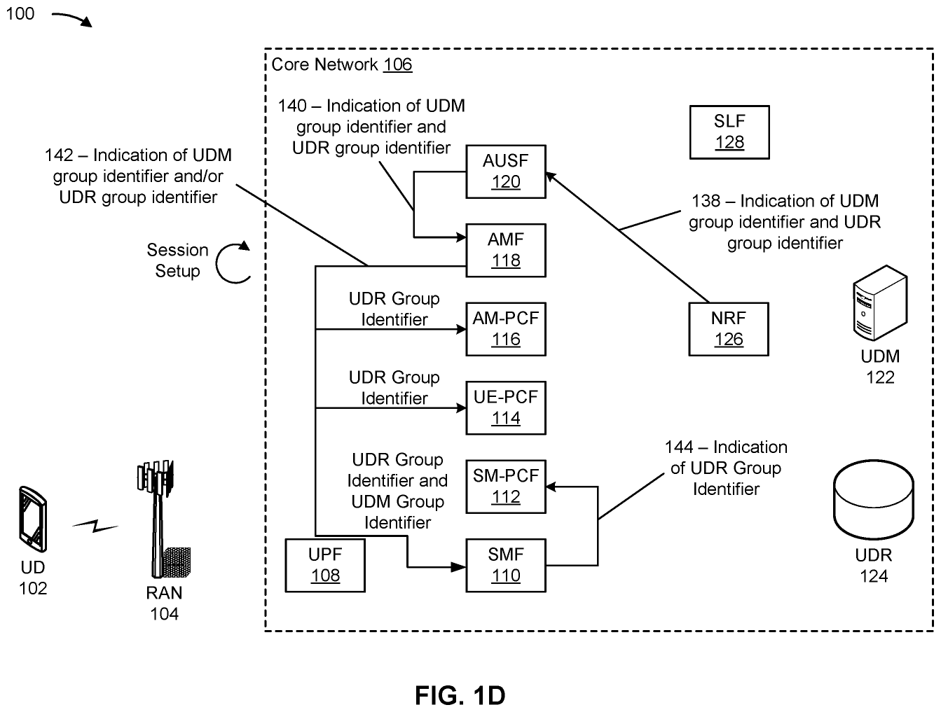

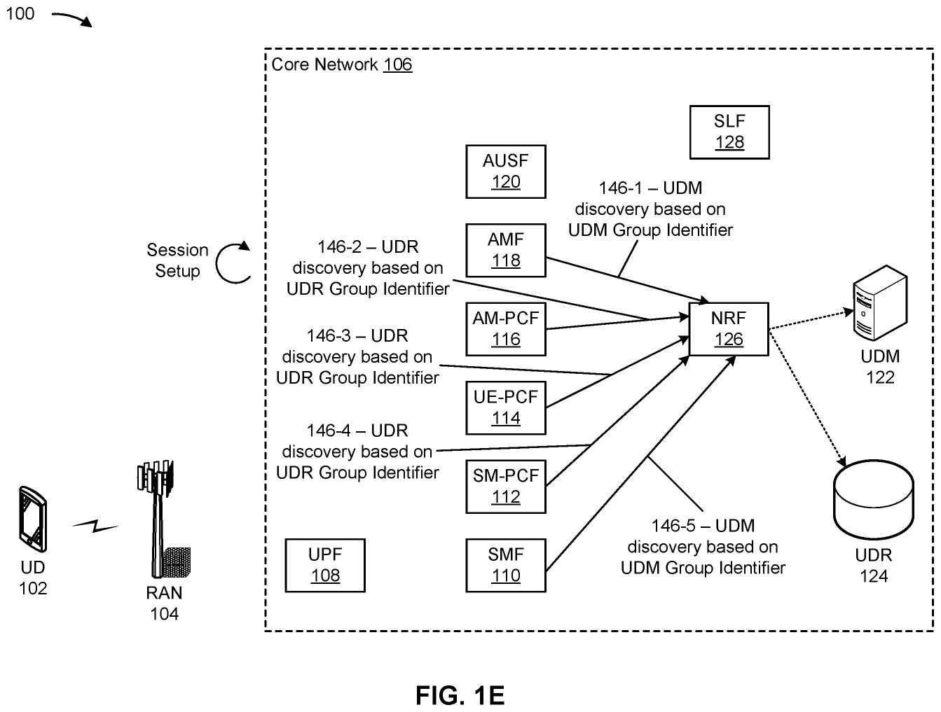

FIGS. 1A-1E are diagrams of an example 100 associated with session setup or registration in a core network. As shown in FIGS. 1A, example 100 includes a user device (UD) 102, a radio access network (RAN) 104, and a core network 106 (e.g., a 5G core network).

As shown in FIG. 1A, the user device 102 may communicate with the core network 106 via the RAN 104. For example, the user device 102 and the RAN 104 may communicate by exchanging wireless communications on a wireless communication link. The wireless communication may include a downlink (e.g., a link from the RAN 104 to the user device 102) and an uplink (e.g., a link from the user device 102 to the RAN 104). The RAN 104 and the core network 106 may communicate on wired and/or wireless communication links.

The user device 102 may be associated with a user profile. The user profile may be associated with a subscriber (e.g., a user) of a wireless network that includes the RAN 104 and the core network 106. The user profile may include information associated with the subscriber. For example, the user profile may include a SUPI (or another type of identifier such as an international mobile subscriber identity (IMSI)) associated with the subscriber. As another example, the user profile may include an indication of the wireless network carrier to which the user subscriber is subscribed. As another example, the user profile may include a mobile equipment identifier (MEID) of the user device 102 associated with the subscriber. The user profile may be stored in a subscriber identity module (SIM) card that is inserted into the user device 102, may be stored in an electronic SIM (eSIM) device on the user device 102, may be stored in a universal SIM (USIM) on a universal integrated circuit card (UICC) in the user device 102, and/or may be stored elsewhere on the user device 102.

The SUPI is a globally unique identifier that is allocated to each subscriber. The SUPI may include a string (e.g., a 15 digit string) of alphanumeric characters. The string in the SUPI or in another identifier may include a subset of digits indicating a mobile network code (MNC) associated with the wireless network carrier, a subset of digits indicating a mobile country code (MCC), and/or a subset of digits indicating a mobile subscriber identification number (MSIN) associated with the subscriber, among other examples.

As further shown in FIG. 1A, the core network 106 may be logically and/or physically arranged into a plurality of network slices or Segment 1 through Segment N. Each segment may be associated with a UDM device and UDR device group. Each segment (and thus, each UDM device and UDR device pair) may be associated with, and may be configured to serve, a subset of subscribers in the wireless network. For example, Segment 1 may be associated with, and may be configured to serve, a first subset of subscribers; Segment 2 may be associated with, and may be configured to serve, a second subset of subscribers; Segment N may be associated with, and may be configured to serve, an nth subset of subscribers; and so on. The assignment of a subscriber to a particular segment may be based on the home geography of the subscriber and/or based on another parameter.

In some implementations, subscribers (that are associated with user devices 102) that are assigned to a UDM device and UDR device group may be assigned to the UDM device and UDR device group in a subscription profile associated with the user devices 102. An identifier (e.g., a SUPI or another type of identifier) assigned to a user device 102 may be associated with (and only with) the UDM device and UDR device group. A subscriber may be assigned to a UDM device and UDR device group based on a rate center associated with the subscriber, IMSI range, location of the subscriber, and/or based on another parameter.

As further shown in FIG. 1A, each UDM device may be associated with a respective and unique UDM group identifier. The UDM group identifier associated with a UDM device may identify the UDM device from other UDM devices in the core network 106. For example, the UDM device in Segment 1 may be associated with associated with a first UDM group identifier (ID 1), the UDM device in Segment 2 may be associated with associated with a second UDM group identifier (ID 2), the UDM device in Segment N may be associated with associated with a first UDM group identifier (ID n), and so on. A UDM group identifier may include one or more components, such as a UDM identifier number, a network slice identifier, and/or another component.

Similarly, each UDR device may be associated with a respective and unique UDR group identifier. The UDR group identifier associated with a UDR device may identify the UDR device from other UDR devices in the core network 106. For example, the UDR device in Segment 1 may be associated with associated with a first UDR group identifier (ID 1), the UDR device in Segment 2 may be associated with associated with a second UDM group identifier (ID 2), the UDR device in Segment N may be associated with associated with a first UDR group identifier (ID n), and so on. A UDR group identifier may include one or more components, such as a UDR identifier number, a network slice identifier, and/or another component.

As shown in FIG. 1B, the core network 106 may include a plurality of network function devices. For example, the core network 106 may include a user plane function (UPF) device (referred to as the UPF 108). As another example, the core network 106 may include a session management function (SMF) device (referred to as the SMF 110). As another example, the core network 106 may include a session management policy control function (SM-PCF) device (referred to as the SM-PCF 112). As another example, the core network 106 may include a user equipment policy control function (UE-PCF) device (referred to as the UE-PCF 114). As another example, the core network 106 may include an access and mobility management policy control function (AM-PCF) device (referred to as the AM-PCF 116). As another example, the core network 106 may include an access and mobility management function (AMF) device (referred to as the AMF 118).

As another example, the core network 106 may include an authentication server function (AUSF) device (referred to as the AUSF 120). As another example, the core network 106 may include a UDM device (referred to as the UDM 122), As another example, the core network 106 may include a UDR device (referred to as the UDR 124). As another example, the core network 106 may include an NRF device (referred to as the NRF 126). As another example, the core network 106 may include a subscriber locator function (SLF) device (referred to as the SLF 128).

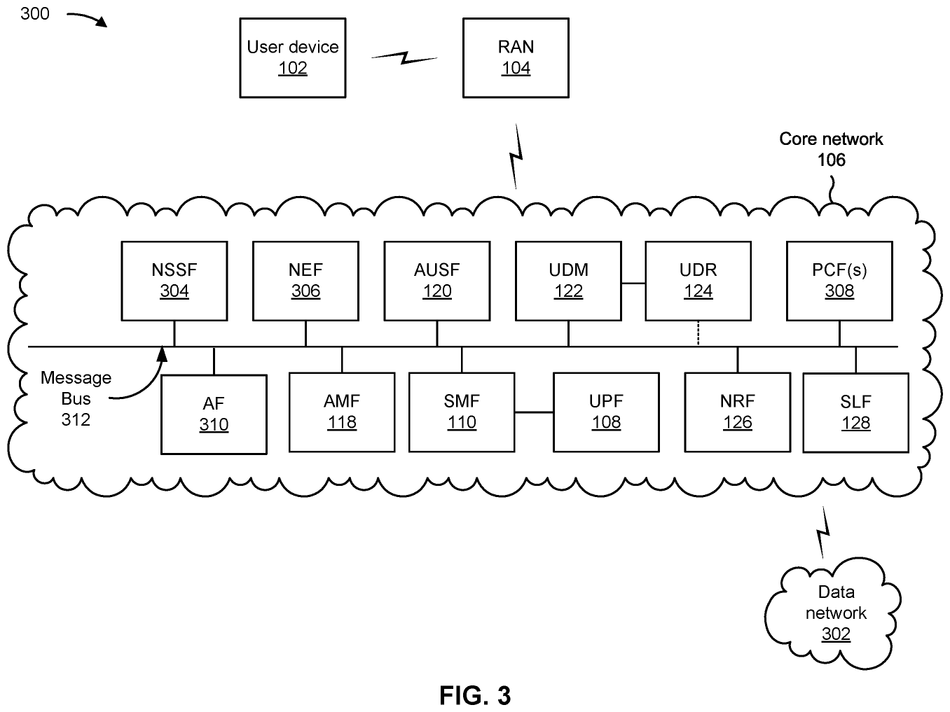

In some implementations, the core network 106 includes additional network function devices, fewer network function devices, and/or a different combination of network function devices. Further details of the user device 102, the RAN 104, the core network 106, the UPF 108, the SMF 110, the SM-PCF 112, the UE-PCF 114, the AM-PCF 116, the AMF 118, the AUSF 120, the UDM 122, the UDR 124, the NRF 126, and the SLF 128 are provided elsewhere herein, such as in connection with FIG. 3.

The network function devices may communicate via various 5G network function interfaces. For example, network function devices may communicate with the SMF 110 via an Nsmf 5G network function interface. As another example, network function devices may communicate with the SM-PCF 112 via an Npcf 5G network function interface. As another example, network function devices may communicate with the UE-PCF 114 via an Npcf 5G network function interface. As another example, network function devices may communicate with the AM-PCF 116 via an Npcf 5G network function interface. As another example, network function devices may communicate with the AMF 118 via an Namf 5G network function interface. As another example, network function devices may communicate with the AUSF 120 via an Nausf 5G network function interface. These interfaces enable propagation of information, provided from the NRF 126, directly between the other network interfaces, which reduces the quantity of lookups that the NRF 126 is to perform during a session setup procedure or during a registration procedure.

As shown in FIG. 1B, the operations described in connection with the example 100 may be performed in connection with a session setup procedure or a registration procedure for the user device 102. At 130, the user device 102 may transmit a request to the AMF 118 through the RAN 104. In other words, the user device 102 communicates the request to the RAN 104 (e.g., wirelessly), and the RAN 104 provides the request to the AMF 118. The AMF 118 receives the request and provides an authentication information request to the AUSF 120 based on the request. The request may include a registration request, a protocol data unit (PDU) session setup request, and/or another type of request.

The AMF 118 may communicate with other network function devices based on receiving the request. As an example, in connection with a registration request, the AMF 118 may communicate with the AUSF 120 to obtain authentication information, may communicate with the AM-PCF 116 to obtain access and mobility management policies, may communicate with the UE-PCF 114 to obtain user equipment (UE) policies, and/or may communicate with the UDM 122 for profile retrieval, among other examples. As another example, in connection with a PDU session setup request, the AMF 118 may relay or forward messages for other network function devices, such as relaying or forwarding messages between the user device 102 and the SMF 110 (which obtains session management policies from the SM-PCF 112 and/or invokes the SM-PCF 112 to perform profile retrieval at the UDM 122, among other examples).

Additionally and/or alternatively, in a non-standalone PDU session request, the request may be received at the SMF 110 from a serving gateway (S-GW) device or a mobility management entity (MME) device. Here, the SMF 110 obtains session management policies from the SM-PCF 112 and/or invokes the SM-PCF 112 to perform profile retrieval at the UDM 122, among other examples.

The request may indicate a subscription concealed identifier (SUCI) associated with the user profile that is associated with the user device 102. The SUCI may include an identifier that contains and conceals the SUPI of the user device 102 for enhanced privacy and security. The user device 102 may generate the SUCI based on the SUPI and a public key associated with the home network of the subscriber associated with the user profile.

The SUCI may be provided to the AUSF 120 based on the request being the first time that the user device 102 is registering with the core network 106. Accordingly, the request may be an initial registration request message. The AUSF 120 may determine, based on the SUCI, the SUPI associated with the user profile that is associated with the user device 102. For example, the AUSF 120 (or another network function device) may perform a decryption operation to decrypt the SUCI and to obtain the SUPI contained in the SUCI.

As shown in FIG. 1C, at 132, the AUSF 120 may initiate a SUPI-based lookup for the user device 102. The AUSF 120 may initiate the SUPI-based lookup by transmitting a request to the NRF 126. The request may include a request to discover the UDM 122 associated with the user profile of the user device 102. The request may implicitly or explicitly indicate that the NRF 126 is to provide the AUSF 120 with an indication of a UDM group identifier associated with the UDM 122 (and, in some cases, one or more other UDMs that are part of the same UDM group as the UDM 122) that is associated with the user profile of the user device 102. The request may further include an indication of the SUPI associated with the user profile of the user device 102.

The NRF 126 may receive the request from the AUSF 120 and, at 134, may perform the SUPI-based lookup based on receiving the request. In particular, the NRF 126 may query the SLF 128 using the SUPI associated with the user profile of the user device 102 to determine the UDM group identifier associated with the UDM 122 that is associated with the user profile of the user device 102. The NRF 126 may provide an indication of the SUPI to the SLF 128. The SUPI-based lookup may include an indication to provide the UDM group identifier.

The SUPI-based lookup may include an indication to provide a UDR group identifier that is associated with the UDR 124 that is associated with the UDM 122. The UDR group identifier may also be associated with one or more other UDRs that are part of the same UDR group as the UDR 124. The UDR 124 may be associated with the UDM 122 in that the UDR 124 and the UDM 122 may be associated with the same segment or network slice of the core network 106. The SUPI-based lookup may also include an indication to provide a charging function (CHF) group identifier. The CHF group identifier may be associated with a CHF device that is associated with the user device 102. The NRF 126 may include an indication to provide the UDR group identifier based on receiving, from the AUSF 120, an explicit indication to provide the UDR group identifier to the AUSF 120. The NRF 126 may include an indication to provide the CHF group identifier based on receiving, from the AUSF 120, an explicit indication to provide the CHF group identifier to the AUSF 120. Additionally and/or alternatively, the NRF 126 may treat the request to provide the UDM group identifier as an implicit indication to also provide the UDR group identifier and/or the CHF group identifier. Accordingly, the NRF 126 may include an indication to provide the UDR group identifier and/or the CHF group identifier based on receiving, from the AUSF 120, only an indication to provide the UDM group identifier to the AUSF 120.

At 136, the SLF 128 may respond with an indication of the UDM group identifier associated with the UDM 122 that is associated with the user profile of the user device 102. The SLF 128 may identify the UDM group identifier based on an association, between the SUPI and the UDM group identifier, stored in the SLF 128. Moreover, the SLF 128 may respond with an indication of the UDR group identifier associated with the UDR 124 and/or the CHF group identifier associated with a CHF device. In some implementations, the SLF 128 may identify the UDR group identifier based on an association, between the SUPI and the UDR group identifier, stored in the SLF 128. In some implementations, the SLF 128 may identify the UDR group identifier based on an association, between the UDM group identifier and the UDR group identifier, stored in the SLF 128. In some implementations, the SLF 128 may identify the CHF group identifier based on an association, between the SUPI and the CHF group identifier, stored in the SLF 128. In some implementations, the SLF 128 may identify the CHF group identifier based on an association, between the UDM group identifier and the CHF group identifier, stored in the SLF 128.

As shown in FIG. 1D, at 138, the NRF 126 may transmit an indication of the UDM group identifier and the UDR group identifier (and in some cases, the CHF group identifier) to the AUSF 120. The NRF 126 may transmit the indication of the UDM group identifier and the UDR group identifier to the AUSF 120 based on receiving the request from the AUSF 120. In some implementations, the NRF 126 may provide the indication of the UDM group identifier and the UDR group identifier to the AUSF 120 via the Nausf 5G network function interface.

Alternative to the operations described in connection with 136 and 138, the AUSF 120 may obtain the UDR group identifier from another network function device such as the UDM 122. The AUSF 120 may then query the UDM 122 (e.g., using the SUPI) to obtain subscriber authentication information that is associated with the subscriber associated with the user device 102. The UDM 122 can push the UDR group identifier to the AUSF 120 (either because the AUSF 120 explicitly or implicitly requested the UDR group identifier from the UDM 122, or because the UDM 122 proactively determines to push the UDR group identifier to the AUSF 120).

At 140, the AUSF 120 may transmit the indication of the UDM group identifier and the UDR group identifier to the AMF 118. The AUSF 120 may also transmit an indication of the CHF group identifier to the AMF 118. In some implementations, the AUSF 120 may transmit (and the AMF 118 may receive) the indication of the UDM group identifier, the UDR group identifier, and/or the CHF group identifier via the Nausf 5G network function interface. In some implementations, the AUSF 120 may transmit the indication of the UDM group identifier, the UDR group identifier, and/or the CHF group identifier to the AMF 118 based on receiving the indication of the UDM group identifier, the UDR group identifier, and/or the CHF group identifier from the NRF 126.

At 142, the AMF 118 may transmit the indication of the UDM group identifier and/or the UDR group identifier to one or more other network function devices in the core network 106. The AMF 118 may also transmit an indication of the CHF group identifier to one or more other network function devices in the core network 106. For example, the AMF 118 may transmit the indication of the UDR group identifier to the AM-PCF 116 (e.g., via an Npcf 5G network function interface). As another example, the AMF 118 may transmit the indication of the UDR group identifier to the UE-PCF 114 (e.g., via an Npcf 5G network function interface). As another example, the AMF 118 may transmit the indication of the UDM group identifier and the UDR group identifier (and/or the CHF group identifier) to the SMF 110 (e.g., via an Nsmf 5G network function interface). Additionally and/or alternatively, the AMF 118 may provide, to the other network function devices in the core network 106, access to the UDM group identifier and/or access to the UDR group identifier. This may include transmitting or providing the UDM group identifier and/or access to the UDR group identifier, as well as permitting the network function devices in the core network 106 the UDM group identifier and/or access to the UDR group identifier on the AMF 118.

At 144, other network function devices in the core network 106 may additionally propagate the indication of the UDM group identifier and/or the UDR group identifier to one or more other network function devices in the core network 106. For example, the SMF 110 may transmit the indication of the UDR group identifier to the SM-PCF 112 (e.g., via an Npcf 5G network function interface).

In this way, only the AUSF 120 performs the SUPI-based lookup with the NRF 126 during the registration procedure. The AMF 118 and the one or more other network function devices do not need the NRF 126 to repeat the SUPI-based lookup performed at 132-134. Instead, the AMF 118 and the one or more other network function devices can proceed directly to obtaining user data from the UDM 122 using the UDM group identifier and/or from the UDR 124 using the UDR group identifier.

It is to be noted that, while the example 100 includes the AUSF 120 transmitting the indication of the UDM group identifier and the UDR group identifier to the AMF 118, and the AMF 118 transmitting the indication of the UDM group identifier and/or the UDR group identifier to other network function devices included in the core network 106, similar operations as described in connection with FIGS. 1C-1E may be performed by another network function device. For example, the SMF 110 may receive the indication of the UDM group identifier and the UDR group identifier and may transmit the indication of the UDM group identifier and/or the UDR group identifier to other network function devices included in the core network 106. As another example, the AMF 118 may receive the indication of the UDM group identifier and the UDR group identifier and may transmit the indication of the UDM group identifier and/or the UDR group identifier to other network function devices included in the core network 106. Generally, the first network function device in the core network 106 that receives the indication of the UDM group identifier and the UDR group identifier from the NRF 126 may transmit the indication of the UDM group identifier and/or the UDR group identifier to other network function devices included in the core network 106. In this way, the other network function devices do not need the NRF 126 to repeat the SUPI-based lookup performed at 132-134 for the other network function devices. Instead, the other network function devices can proceed directly to obtaining user data from the UDM 122 using the UDM group identifier and/or from the UDR 124 using the UDR group identifier.

As shown in FIG. 1E, at 146-1 through 146-5, one or more of the network function devices in the core network 106 may perform UDM discovery and/or UDR discovery based on the UDM group identifier and/or the UDR group identifier. The one or more of the network function devices in the core network 106 may perform UDM discovery and/or UDR discovery to discover the UDMs and/or UDRs that are in the UDM group and/or the UDR group associated with the subscriber that is associated with the user device 102. Once the one or more of the network function devices have discovered the UDMs and/or UDRs, the one or more of the network function devices may query one or more of the UDMs and/or one or more of the UDRs to obtain user data associated with the user profile that is associated with the user device 102. The user data may include an indication of the services that the subscriber associated with the user profile is permitted to access at the UDM 122 and/or at the UDR 124; may include an indication of the service tier that the subscriber associated with the user profile is permitted to access at the UDM 122 and/or at the UDR 124; and/or may include other user data.

As an example, at 146-1, the AMF 118 may query the NRF 126 for UDM discovery, based on the UDM group identifier, to obtain user data from the UDM 122. As another example, at 146-2, the AM-PCF 116 may query the NRF 126 for UDR discovery, based on the UDR group identifier, to obtain user data from the UDR 124. As another example, at 146-3, the UE-PCF 114 may query the NRF 126 for UDR discovery, based on the UDR group identifier, to obtain user data from the UDR 124. As another example, at 146-4, the SM-PCF 112 may query the NRF 126 for UDR discovery, based on the UDR group identifier, to obtain user data from the UDR 124. As another example, at 146-5, the SMF 110 may query the NRF 126 for UDM discovery, based on the UDM group identifier, to obtain user data from the UDM 122.

In some implementations, the AUSF 120, the AMF 118, and/or another network function device in the core network 106 may store (e.g., may cache) UDM group information (e.g., information identifying the UDM devices in the UDM group associated with the UDM group identifier) and/or UDR group information (e.g., information identifying the UDR devices in the UDR group associated with the UDR group identifier). This enables the AUSF 120, the AMF 118, and/or another network function device to satisfy additional requests using the stored information, which further reduces lookups and signaling overhead in the core network 106 for subsequent session setup procedures or registration procedures. In some implementations, the AUSF 120, the AMF 118, and/or another network function device stores a mapping between the UDM group identifier and the individual UDM instances that comprise that UDM group. In some implementations, the AUSF 120, the AMF 118, and/or another network function device may use the cached information to determine the individual UDMs in the UDM group for a subsequent session setup procedure or registration procedure, eliminating the need for an additional discovery request to the NRF 126. In some implementations, the AUSF 120, the AMF 118, and/or another network function device stores a mapping between the UDR group identifier and the individual UDR instances that comprise that UDR group. In some implementations, the AUSF 120, the AMF 118, and/or another network function device may use the cached information to determine the individual UDRs in the UDR group for a subsequent session setup procedure or registration procedure, eliminating the need for an additional discovery request to the NRF 126.

As an example of the above, when the AUSF 120 determines to obtain the subscriber profile information for a subscriber associated with a UDR Group 2 in Segment 2 of the core network 106, the AUSF 120 first sends a message to the NRF 126 to discover the UDRs in UDR Group 2. The NRF 126 provides the UDR group information associated with UDR Group 2 (e.g., information identifying UDR1, UDR2 and UDR3 are in UDR Group 2), the AUSF 120 selects one of UDR1, UDR2, or UDR3 and queries that UDR to get the subscribers profile information. Then, the AUSF 120 will cache the UDR group information indicating that UDR1, UDR2 and UDR3 are in UDR Group 2. The next time the AUSF 120 needs to obtain the subscriber profile information for a subscriber in UDR Group 2, the AUSF 120 does not have to go to the NRF 126 to learn what UDRs are in UDR Group 2 since the AUSF 120 has this information cached.

As indicated above, FIGS. 1A-1E are provided as an example. Other examples may differ from what is described with regard to FIGS. 1A-1E. The number and arrangement of devices shown in FIGS. 1A-1E are provided as an example. In practice, there may be additional devices, fewer devices, different devices, or differently arranged devices than those shown in FIGS. 1A-1E. Furthermore, two or more devices shown in FIGS. 1A-1E may be implemented within a single device, or a single device shown in FIGS. 1A-1E may be implemented as multiple, distributed devices. Additionally, or alternatively, a set of devices (e.g., one or more devices) shown in FIGS. 1A-1E may perform one or more functions described as being performed by another set of devices shown in FIGS. 1A-1E.

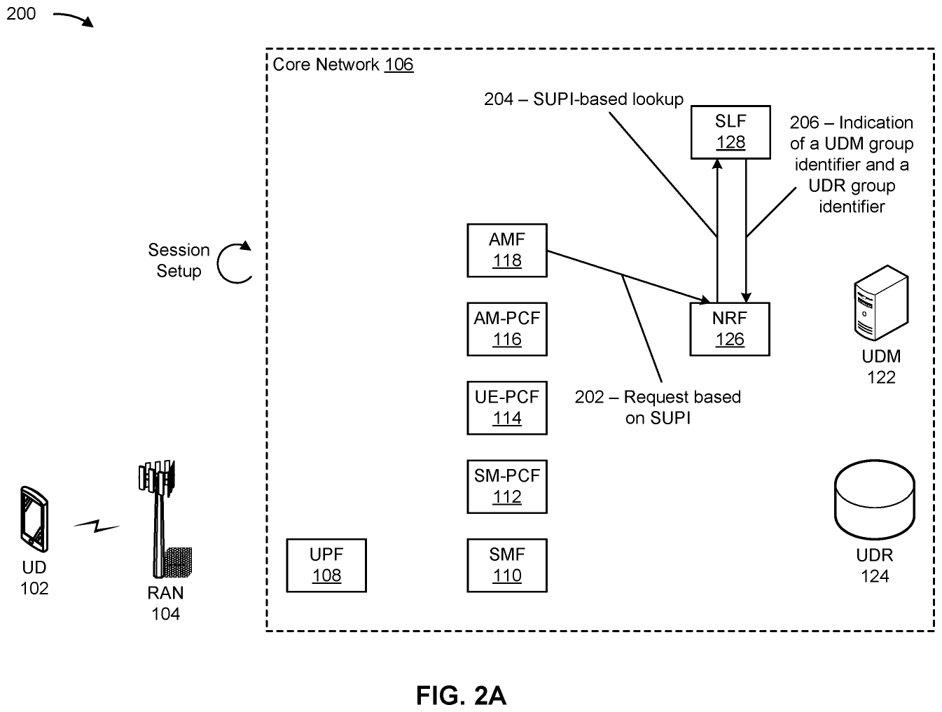

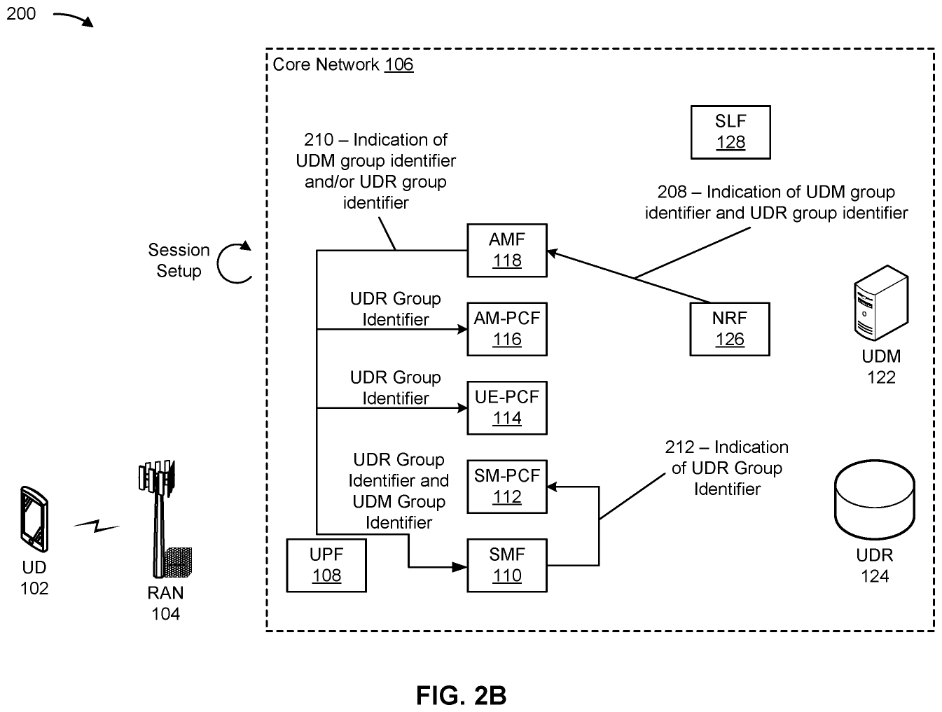

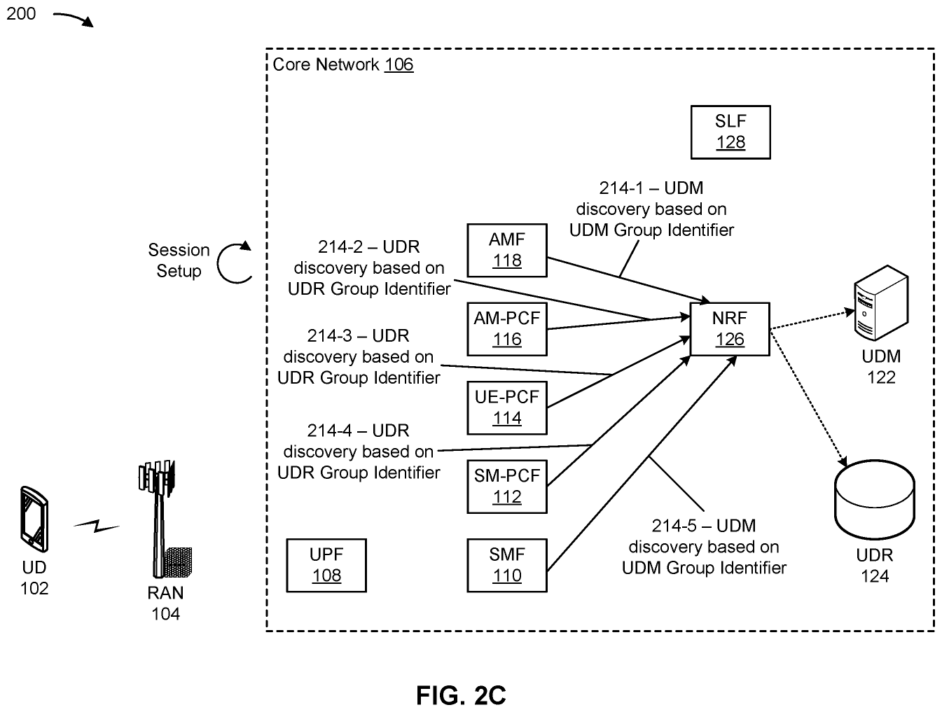

FIGS. 2A-2C are diagrams of an example 200 associated with session setup or registration in a core network. As shown in FIGS. 2A, example 200 includes a similar combination of devices as the example 100 of FIGS. 1A-1E. For example, the example 200 may include the user device 102, the RAN 104, and the core network 106. However, in the example 200 of FIGS. 2A-2C may include a 5G global unique temporary identifier (5G-GUTI) registration procedure. Thus, the example 200 may include an example in which a session setup procedure or a registration procedure is performed for a user device 102 that has previously registered with the core network 106 and is assigned a global unique temporary identifier (GUTI). Thus, the user device 102 is already authenticated through the AUSF 120, and the AUSF 120 can be omitted from the session setup procedure or the registration procedure. The AMF 118 may generate and store the GUTI, along with a mapping of the GUTI to the SUPI, for subsequent registrations and/or session requests.

In some implementations, the operations described in connection with the example 200 may be performed in connection with a PDU session setup procedure or a registration procedure for the user device 102. The session setup procedure or the registration procedure may be initiated based on reception of a request at the AMF 118. The request may be similar to the request at 130 described in connection with FIG. 1B. However, the request may indicate the GUTI associated with the user device 102 instead of the SUCI. The AMF 118 may use the GUTI to determine the SUPI associated with the user profile of the user device 102.

As further shown in FIG. 2A, at 202, the AMF 118 may initiate a SUPI-based lookup for the user device 102 instead of the AUSF 120. The AMF 118 may initiate the SUPI-based lookup by transmitting a request to the NRF 126. The request may include a request to discover the UDM 122 associated with the user profile of the user device 102. The request may implicitly or explicitly indicate that the NRF 126 is to provide the AMF 118 with an indication of a UDM group identifier associated with the UDM 122 that is associated with the user profile of the user device 102. The request may further include an indication of the SUPI associated with the user profile of the user device 102.

The NRF 126 may receive the request from the AMF 118 and, at 204, may perform the SUPI-based lookup based on receiving the request. In particular, the NRF 126 may query the SLF 128 using the SUPI associated with the user profile of the user device 102 to determine the UDM group identifier associated with the UDM 122 that is associated with the user profile of the user device 102. The NRF 126 may provide an indication of the SUPI to the SLF 128. The SUPI-based lookup may include an indication to provide the UDM group identifier.

The SUPI-based lookup may include an indication to provide a UDR group identifier that is associated with the UDR 124 that is associated with the UDM 122. The UDR 124 may be associated with the UDM 122 in that the UDR 124 and the UDM 122 may be associated with the same segment or network slide of the core network 106. The SUPI-based lookup may also include an indication to provide a CHF group identifier that is associated with a CHF device associated with the subscriber of the user device 102. The NRF 126 may include an indication to provide the UDR group identifier based on receiving, from the AMF 118, an explicit indication to provide the UDR group identifier to the AMF 118. Additionally and/or alternatively, the NRF 126 may treat the request to provide the UDM group identifier as an implicit indication to also provide the UDR group identifier. Accordingly, the NRF 126 may include an indication to provide the UDR group identifier based on receiving, from the AMF 118, only an indication to provide the UDM group identifier to the AMF 118.

The NRF 126 may include an indication to provide the CHF group identifier based on receiving, from the AMF 118, an explicit indication to provide the CHF group identifier to the AMF 118. Additionally and/or alternatively, the NRF 126 may treat the request to provide the UDM group identifier as an implicit indication to also provide the CHF group identifier. Accordingly, the NRF 126 may include an indication to provide the CHF group identifier based on receiving, from the AMF 118, only an indication to provide the UDM group identifier to the AMF 118.

At 206, the SLF 128 may respond with an indication of the UDM group identifier associated with the UDM 122 that is associated with the user profile of the user device 102. The SLF 128 may identify the UDM group identifier based on an association, between the SUPI and the UDM group identifier, stored in the SLF 128. Moreover, the SLF 128 may respond with an indication of the UDR group identifier associated with the UDR 124 and/or an indication of the CHF group identifier. In some implementations, the SLF 128 may identify the UDR group identifier based on an association, between the SUPI and the UDR group identifier, stored in the SLF 128. In some implementations, the SLF 128 may identify the UDR group identifier based on an association, between the UDM group identifier and the UDR group identifier, stored in the SLF 128.

As shown in FIG. 2B, at 208, the NRF 126 may transmit an indication of the UDM group identifier, the UDR group identifier, and/or the CHF group identifier to the AMF 118. The NRF 126 may transmit the indication of the UDM group identifier, the UDR group identifier, and/or the CHF group identifier to the AMF 118 based on receiving the request from the AMF 118. In some implementations, the NRF 126 may provide the indication of the UDM group identifier, the UDR group identifier, and/or the CHF group identifier to the AMF 118 via the Nnrf 5G network function interface.

Alternatively, the AMF 118 may obtain the UDR group identifier from another network function device such as the UDM 122. Here, the AMF 118 may query the UDM 122 for a subscriber profile associated with the subscriber of the user device 102. The UDM 122 may provide the subscriber profile, along with the indication of the UDR group identifier, to the AMF 118 based on receiving the request for the subscriber profile. The UDM 122 may provide the indication of the UDR group identifier based on an explicit or implicit indication in the request for the subscriber profile, or may proactively provide the UDR group identifier without input from the AMF 118.

In some implementations, the UDM 112 transmits the indication of the UDR group identifier and/or the CHF group identifier in the subscriber profile that is transmitted to the AMF 118. The subscriber profile may include various sections, such as an access management profile, a session management profile, and/or another section. In some implementations, the subscriber profile may include a particular section that is dedicated for indicating the UDM group identifier, the UDR group identifier, and/or the CHF group identifier.

At 210, the AMF 118 may transmit the indication of the UDM group identifier, the UDR group identifier, and/or the CHF group identifier to one or more other network function devices in the core network 106. For example, the AMF 118 may transmit the indication of the UDR group identifier to the AM-PCF 116 (e.g., via an Npcf 5G network function interface). As another example, the AMF 118 may transmit the indication of the UDR group identifier to the UE-PCF 114 (e.g., via an Npcf 5G network function interface). For example, the AMF 118 may transmit the indication of the UDM group identifier and the UDR group identifier to the SMF 110 (e.g., via an Nsmf 5G network function interface). At 212, other network function devices in the core network 106 may additionally propagate the indication of the UDM group identifier and/or the UDR group identifier to one or more other network function devices in the core network 106. For example, the SMF 110 may transmit the indication of the UDR group identifier to the SM-PCF 112 (e.g., via an Npcf 5G network function interface).

In this way, only the AMF 118 performs the SUPI-based lookup with the NRF 126 during the session setup or the registration procedure. The one or more other network function devices do not need the NRF 126 to repeat the SUPI-based lookup performed at 132-134. Instead, the one or more other network function devices can proceed directly to obtaining user data from the UDM 122 using the UDM group identifier and/or from the UDR 124 using the UDR group identifier.

It is to be noted that, while the example 200 includes the AMF 118 transmitting the indication of the UDM group identifier and/or the UDR group identifier to other network function devices included in the core network 106, similar operations as described in connection with FIGS. 2A and 2B may be performed by another network function device. For example, the SMF 110 may receive the indication of the UDM group identifier and the UDR group identifier and may transmit the indication of the UDM group identifier and/or the UDR group identifier to other network function devices included in the core network 106. Generally, the first network function device in the core network 106 that receives the indication of the UDM group identifier and the UDR group identifier from the NRF 126 may transmit the indication of the UDM group identifier and/or the UDR group identifier to other network function devices included in the core network 106. In this way, the other network function devices do not need the NRF 126 to repeat the SUPI-based lookup performed at 202-206 for the other network function devices. Instead, the other network function devices can proceed directly to obtaining user data from the UDM 122 using the UDM group identifier and/or from the UDR 124 using the UDR group identifier.

As shown in FIG. 2C, at 214-1 through 214-5, one or more of the network function devices in the core network 106 may perform UDM discovery and/or UDR discovery based on the UDM group identifier and/or the UDR group identifier. The one or more of the network function devices in the core network 106 may perform UDM discovery and/or UDR discovery to obtain user data associated with the user profile that is associated with the user device 102. The user data may include an indication of the services that the subscriber associated with the user profile is permitted to access at the UDM 122 and/or at the UDR 124; may include an indication of the service tier that the subscriber associated with the user profile is permitted to access at the UDM 122 and/or at the UDR 124; and/or may include other user data.

As an example, at 214-1, the AMF 118 may query the NRF 126 for UDM discovery, based on the UDM group identifier, to obtain user data from the UDM 122. As another example, at 214-2, the AM-PCF 116 may query the NRF 126 for UDR discovery, based on the UDR group identifier, to obtain user data from the UDR 124. As an example, at 214-3, the UE-PCF 114 may query the NRF 126 for UDR discovery, based on the UDR group identifier, to obtain user data from the UDR 124. As another example, at 214-4, the SM-PCF 112 may query the NRF 126 for UDR discovery, based on the UDR group identifier, to obtain user data from the UDR 124. As another example, at 214-5, the SMF 110 may query the NRF 126 for UDM discovery, based on the UDM group identifier, to obtain user data from the UDM 122.

In some implementations, the AUSF 120, the AMF 118, and/or another network function device in the core network 106 may store (e.g., may cache) UDM group information (e.g., information identifying the UDM devices in the UDM group associated with the UDM group identifier) and/or UDR group information (e.g., information identifying the UDR devices in the UDR group associated with the UDR group identifier). This enables the AUSF 120, the AMF 118, and/or another network function device to satisfy additional requests using the stored information, which further reduces lookups and signaling overhead in the core network 106 for subsequent session setup procedures or registration procedures. In some implementations, the AUSF 120, the AMF 118, and/or another network function device stores a mapping between the UDM group identifier and the individual UDM instances that comprise that UDM group. In some implementations, the AUSF 120, the AMF 118, and/or another network function device may use the cached information to determine the individual UDMs in the UDM group for a subsequent session setup procedure ore registration procedure, eliminating the need for an additional discovery request to the NRF 126. In some implementations, the AUSF 120, the AMF 118, and/or another network function device stores a mapping between the UDR group identifier and the individual UDR instances that comprise that UDR group. In some implementations, the AUSF 120, the AMF 118, and/or another network function device may use the cached information to determine the individual UDRs in the UDR group for a subsequent session setup procedure or registration procedure, eliminating the need for an additional discovery request to the NRF 126.

As indicated above, FIGS. 2A-2C are provided as an example. Other examples may differ from what is described with regard to FIGS. 2A-2C. The number and arrangement of devices shown in FIGS. 2A-2C are provided as an example. In practice, there may be additional devices, fewer devices, different devices, or differently arranged devices than those shown in FIGS. 2A-2C. Furthermore, two or more devices shown in FIGS. 2A-2C may be implemented within a single device, or a single device shown in FIGS. 2A-2C may be implemented as multiple, distributed devices. Additionally, or alternatively, a set of devices (e.g., one or more devices) shown in FIGS. 2A-2C may perform one or more functions described as being performed by another set of devices shown in FIGS. 2A-2C.

FIG. 3 is a diagram of an example environment 300 in which systems and/or methods described herein may be implemented. As shown in FIG. 3, example environment 300 may include a user device 102, a RAN 104, a core network 106, and a data network 302. Devices and/or networks of example environment 300 may interconnect via wired connections, wireless connections, or a combination of wired and wireless connections.

The user device 102 includes one or more devices capable of receiving, generating, storing, processing, and/or providing information, such as information described herein. For example, the user device 102 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device. The user device 102 may initiate a connection establishment procedure with the RAN 104, which may include transmitting a request described herein. The connection establishment procedure may include registration of the user device 102 with the RAN 104 and/or with the core network 106. The connection establishment procedure may include a PDU session setup procedure to establish a PDU session for which the user device 102 may access the data network 302 via the RAN 104 and the core network 106.

The RAN 104 may support, for example, a cellular radio access technology (RAT). The RAN 104 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for user device 102. The RAN 104 may transfer traffic between the user device 102 (e.g., using a cellular RAT), one or more base stations (e.g., using a wireless interface or a backhaul interface, such as a wired backhaul interface), and/or the core network 106. The RAN 104 may provide one or more cells that cover geographic areas.

In some implementations, the RAN 104 may perform scheduling and/or resource management for the user device 102 covered by the RAN 104 (e.g., the user device 102 covered by a cell provided by the RAN 104). In some implementations, the RAN 104 may be controlled or coordinated by a network controller, which may perform load balancing, network-level configuration, and/or other operations. The network controller may communicate with the RAN 104 via a wireless or wireline backhaul. In some implementations, the RAN 104 may include a network controller, a self-organizing network (SON) module or component, or a similar module or component. In other words, the RAN 104 may perform network control, scheduling, and/or network management functions (e.g., for uplink, downlink, and/or sidelink communications of the user device 102 covered by the RAN 104).

In some implementations, the core network 106 may include an example functional architecture in which systems and/or methods described herein may be implemented. For example, the core network 106 may include an example architecture of a fifth generation (5G) next generation (NG) core network included in a 5G wireless telecommunications system. While the example architecture of the core network 106 shown in FIG. 3 may be an example of a service-based architecture, in some implementations, the core network 106 may be implemented as a reference-point architecture and/or a 4G core network, among other examples.

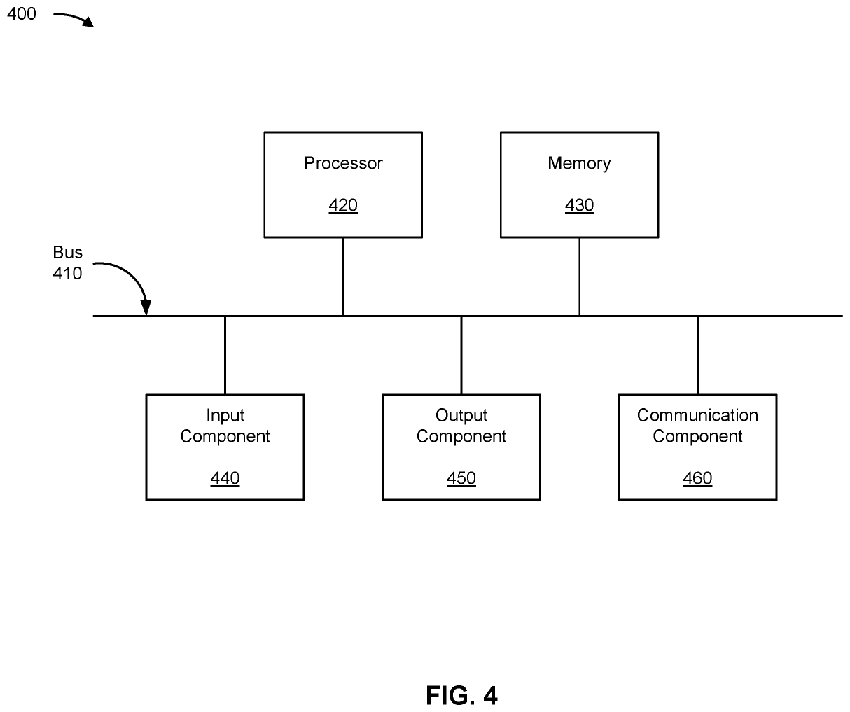

As shown in FIG. 3, the core network 106 may include a number of functional elements. The functional elements may include, for example, a UPF 108 (e.g., a UPF device), an SMF 110 (e.g., an SMF device), an AMF 118 (e.g., an AMF device), an AUSF 120 (e.g., an AUSF 120 device), a UDM 122 (e.g., a UDM device), a UDR 124 (e.g., a UDR device), an NRF 126 (e.g., an NRF device), an SLF 128 (e.g., an SLF device), a network slice selection function (NSSF) 304 (e.g., an NSSF device), a network exposure function (NEF) 306 (e.g., an NEF device), one or more policy control functions (PCFs) 308 (e.g., one or more PCF devices), and/or an application function (AF) 310 (e.g., an AF device), among other examples. These functional elements may be communicatively connected via a message bus 312. Each of the functional elements shown in FIG. 3 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment. In some implementations, one or more of the functional elements may be implemented by one or more devices, such as one or more devices 400 illustrated and described in connection with FIG. 4.

The UPF 108 includes one or more devices that serve as an anchor point for intraRAT and/or interRAT mobility. The UPF 108 may apply rules to packets, such as rules pertaining to packet routing, traffic reporting, and/or handling user plane QoS, among other examples.

The SMF 110 includes one or more devices that support the establishment, modification, and release of communication sessions in the wireless telecommunications system. For example, the SMF 110 may configure traffic steering policies at the UPF 108 and/or may enforce user equipment IP address allocation and policies, among other examples.

The AMF 118 includes one or more devices that act as a termination point for non-access stratum (NAS) signaling and/or mobility management, among other examples.

The AUSF 120 includes one or more devices that act as an authentication server and support the process of authenticating the user device 102 in the wireless telecommunications system.

The UDM 122 includes one or more devices that maintain (e.g., update, store, provide) user data and profiles in the wireless telecommunications system. The UDM 122 may be used for fixed access and/or mobile access in the core network 106. The user data and profiles may be stored in the UDR 124, which includes a data repository for storing the user data and profiles.

The NRF 126 includes one or more devices that provide a single record of all network functions available in the core network 106, together with a profile of each network function and services supported by each network function. The NRF 126 may allow other network functions to subscribe to, and get notified about, registration in the NRF 126 of new network function instances. In addition to maintaining profiles, the NRF 126 also supports service discovery functions, enabling other network functions to obtain information regarding available network functions that can support specific services.

The SLF 128 includes one or more devices that store, maintain, and/or provide subscription information associated with a plurality of user profiles, such as a user profile associated with a user device 102. The subscription information may include an indication of a home subscriber slice (HSS) associated with a user profile, an indication of a UDM 122 and/or a UDR 124 to which the user profile is assigned, a UDM profile associated with the user profile, a subscriber profile associated with the user profile, and/or other subscriber information associated with the user profile.

The data network 302 includes one or more wired and/or wireless data networks. For example, the data network 302 may include an IP Multimedia Subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

The NSSF 304 includes one or more devices that select network slice instances for the user device 102. By providing network slicing, the NSSF 304 allows an operator to deploy multiple substantially independent end-to-end networks potentially with the same infrastructure. In some implementations, each slice may be customized for different services.

The NEF 306 includes one or more devices that support exposure of capabilities and/or events in the wireless telecommunications system to help other entities in the wireless telecommunications system discover network services.

The PCF(s) 308 includes one or more devices that provide a policy framework that incorporates network slicing, roaming, packet processing, and/or mobility management, among other examples. The PCF(s) 308 may include an SM-PCF 112 (e.g., an SM-PCF device), a UE-PCF 114 (e.g., a UE-PCF device), and/or an AM-PCF 116 (e.g., an AM-PCF device), among other examples. The SM-PCF 112 may include one or more devices that provides a policy framework and maintains rules and policies for session management. The UE-PCF 114 may include one or more devices that provides a policy framework and maintains rules and policies for user devices 102. The AM-PCF 116 may include one or more devices that provides a policy framework and maintains rules and policies for access management.

The AF 310 includes one or more devices that support application influence on traffic routing, access to the NEF 306, and/or policy control, among other examples.

The message bus 312 represents a communication structure for communication among the functional elements. In other words, the message bus 312 may permit communication between two or more functional elements. The network function devices included in the core network 106 may communicate on the message bus 312 using one or more of the 5G network function interfaces described above.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of example environment 300 may perform one or more functions described as being performed by another set of devices of example environment 300.

FIG. 4 is a diagram of example components of a device 400 associated with session setup or registration in a core network. The device 400 may correspond to the user device 102, one or more components of the RAN 104, one or more components of the core network 106, the UPF 108, the SMF 110, the SM-PCF 112, the UE-PCF 114, the AM-PCF 116, the AMF 118, the AUSF 120, the UDM 122, the UDR 124, the NRF 126, the SLF 128, the NSSF 304, the NEF 306, the PCF(s) 308, the AF 310, and/or one or more components in the data network 302. In some implementations, the user device 102, one or more components of the RAN 104, one or more components of the core network 106, the UPF 108, the SMF 110, the SM-PCF 112, the UE-PCF 114, the AM-PCF 116, the AMF 118, the AUSF 120, the UDM 122, the UDR 124, the NRF 126, the SLF 128, the NSSF 304, the NEF 306, the PCF(s) 308, the AF 310, and/or one or more components in the data network 302 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

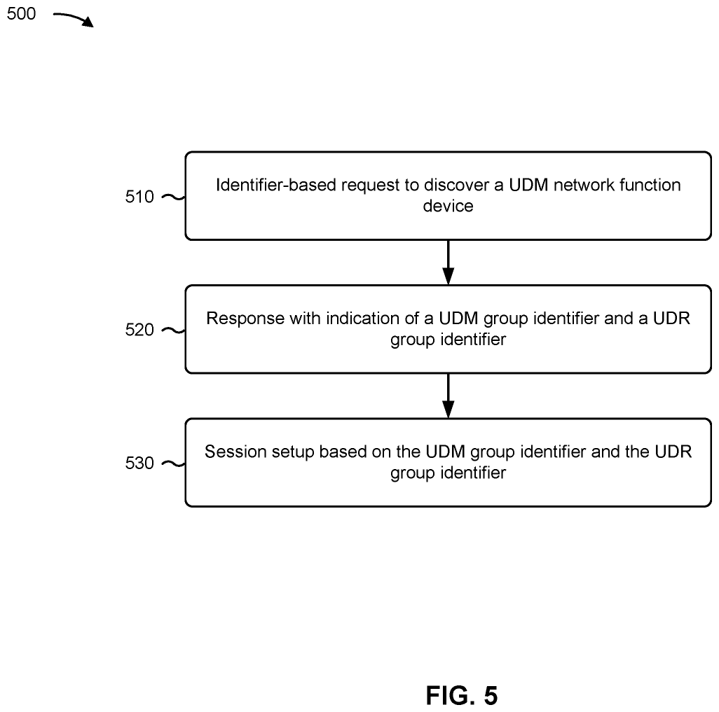

FIG. 5 is a flowchart of an example process 500 associated with session setup or registration in a core network. In some implementations, one or more process blocks of FIG. 5 may be performed by a first network function device (e.g., the UPF 108, the SMF 110, the SM-PCF 112, the UE-PCF 114, the AM-PCF 116, the AMF 118, the AUSF 120, the UDM 122, the UDR 124, the NRF 126, the SLF 128, the NSSF 304, the NEF 306, a PCF 308, and/or the AF 310). In some implementations, one or more process blocks of FIG. 5 may be performed by another device or a group of devices separate from or including the first network function device, such as the user device 102, one or more components of the RAN 104, and/or one or more components of the data network 302, among other examples. Additionally, or alternatively, one or more process blocks of FIG. 5 may be performed by one or more components of device 400, such as processor 420, memory 430, input component 440, output component 450, and/or communication component 460.

As shown in FIG. 5, process 500 may include an identifier-based request to discover a UDM device (block 510). For example, the first network function device may transmit a SUPI-based request to discover a UDM device, as described herein. The UDM device may be associated with a SUPI of a user profile that is assigned to a user device. In some implementations, the first network function may transmit the SUPI-based request to an NRF device in a core network, and the NRF device may receive the SUPI-based request. In some implementations, the first network function may transmit (and the NRF device may receive) an indication of the SUPI associated with a user profile that is associated with the user device. The user profile may be assigned to the UDM device.

As further shown in FIG. 5, process 500 may include a response with an indication of a UDM group identifier and a UDR group identifier (block 520). For example, the first network function device may receive, based on the SUPI-based request, an indication of a UDM group identifier associated with the UDM device and a UDR group identifier associated with a UDR device that is associated with the UDM device, as described herein. In some implementations, the first network function device may also receive an indication of a CHF group identifier. The NRF device may transmit, to the first network function device, the indication of the UDM group identifier and the UDR group identifier to the first network function device based on the SUPI-based request. The first network function device may transmit, to one or more second network function devices included in the core network, an indication of at least one of the UDM group identifier or the UDR group identifier.

The indication of the UDM group identifier and the UDR group identifier may be included in a subscriber profile associated with the user profile, and/or may be included in a standalone message. In some implementations, the NRF device may also transmit, to the first network function device, a UDM profile associated with the user device. In some implementations, the NRF device may also transmit, to the first network function device, a CHF group identifier associated with the user profile. The indication of the CHF group identifier may be included in a subscriber profile associated with the user profile, and/or may be included in a standalone message.

In some implementations, the SUPI-based request explicitly indicates for the NRF device to provide the UDM group identifier and the UDR group identifier to the first network function device. The NRF device may provide the indication of the UDM group identifier and the UDR group identifier to the first network function device based on the SUPI-based request. In some implementations, the SUPI-based request explicitly indicates for the NRF device to provide only the UDM group identifier. The NRF device may provide the UDM group identifier and the UDR group identifier to the first network function device based on the request. In other words, the NRF device treats the indication for the NRF device to provide the UDM group identifier as an implicit indication to also provide the UDR group identifier.

To identify the UDM group identifier and the UDR group identifier, the NRF device may transmit, to an SLF device, a request for the UDM group identifier and the UDR group identifier. The request may include an indication of the SUPI associated with the user profile of the user device. The SLF network function may look up the UDM group identifier and the UDR group identifier using the SUPI and may provide an indication of the UDM group identifier and the UDR group identifier to the NRF device. The NRF may receive the UDM group identifier and the UDR group identifier and may provide an indication of the UDM group identifier and the UDR group identifier to the first network function device.

Alternatively the first network function device (e.g., an AMF device or an AUSF device) may obtain the UDM group identifier and the UDR group identifier from different network function devices. For example, the first network function device may obtain the UDM group identifier from an NRF device, and may obtain the UDR group identifier from a UDM device.

As further shown in FIG. 5, process 500 may include session setup based on the UDM group identifier and the UDR group identifier (block 530). For example, the first network function device may transmit, to the NRF device, at least one of a request for discovery of the UDM device based on the UDM group identifier or a request for discovery of the UDR device based on the UDR group identifier, as described herein. As another example, the one or more second network function devices may transmit, to the NRF device, at least one of a request for discovery of the UDM device based on the UDM group identifier or a request for discovery of the UDR device based on the UDR group identifier, as described herein.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
transmitting, by a first network function device included in a core network, a request for discovery of a unified data management (UDM) device included in the core network;
receiving, by the first network function device and based on the request, an indication of:
a UDM group identifier associated with the UDM device, and
a user data repository (UDR) group identifier associated with a UDR device that is associated with the UDM device; and
providing, by the first network function device and to one or more second network function devices included in the core network, access to at least one of the UDM group identifier or the UDR group identifier.

2. The method of claim 1, wherein transmitting the request for the indication of the UDM device comprises:
transmitting an indication of a subscription permanent identifier (SUPI) associated with a user profile that is associated with a user device,
wherein the user profile is assigned to the UDM device, and
wherein the SUPI is associated with the UDM group identifier and the UDR group identifier.

3. The method of claim 1, wherein the first network function device comprises an access and mobility management function (AMF) device; and
wherein providing access to the at least one of the UDM group identifier or the UDR group identifier to the one or more second network function devices comprises:
transmitting the indication of the at least one of the UDM group identifier or the UDR group identifier to at least one of:
a policy control function (PCF) device, or
a session management function (SMF) device.

4. The method of claim 1, wherein the first network function device comprises an authentication server function (AUSF) device; and
wherein providing access to the at least one of the UDM group identifier or the UDR group identifier to the one or more second network function devices comprises:
transmitting the indication of the at least one of the UDM group identifier or the UDR group identifier to an access and mobility management function (AMF) device.

5. The method of claim 1, wherein transmitting the request comprises:
transmitting the request to a network repository function (NRF) device included in the core network; and
wherein receiving the indication of the UDM group identifier and the UDR group identifier comprises:
receiving the indication of the UDM group identifier and the UDR group identifier from the NRF device.

6. The method of claim 5, wherein the request explicitly indicates for the NRF device to provide the UDM group identifier and the UDR group identifier.

7. The method of claim 5, wherein the request explicitly indicates for the NRF device to provide only the UDM group identifier.

8. The method of claim 1, wherein receiving the indication of the UDM group identifier and the UDR group identifier comprises:
receiving the UDM group identifier from a network repository function (NRF) device; and
receiving the UDR group identifier from the UDM device.

9. A network repository function (NRF) device, comprising:
one or more processors configured to:
receive, from a first network function device included in a core network, a first request for discovery of a unified data management (UDM) device included in the core network,
wherein the first request is based on a subscription permanent identifier (SUPI) associated with a user profile that is associated with a user device;
transmit, to first network function device and based on the first request, an indication of:
a UDM group identifier associated with the UDM device, and
a user data repository (UDR) group identifier associated with a UDR device that is associated with the UDM device; and
receive, from a second network function device included in the core network, a second request for discovery of a UDR device included in the core network,
wherein the UDR device is associated with the UDM device, and
wherein the second request is based on the UDR group identifier.

10. The NRF device of claim 9, wherein the one or more processors are further configured to:
transmit, to a subscription locator function (SLF) device and based on the first request, a third request for the UDM group identifier and the UDR group identifier; and
receive the UDM group identifier and the UDR group identifier from the SLF device based on the third request.

11. The NRF network function of claim 9, wherein the one or more processors, to receive the first request, are configured to:
receive the first request from at least one of:
an authentication server function (AUSF) device, or
an access and mobility management function (AMF) device.

12. The NRF network function of claim 9, wherein the one or more processors, to transmit the indication of the UDM group identifier and the UDR group identifier, are configured to:
transmit, to the first network function device, the indication of the UDM group identifier and the UDR group identifier along with a UDM profile associated with the user profile.

13. The NRF network function of claim 9, wherein the one or more processors, to transmit the indication of the UDM group identifier and the UDR group identifier, are configured to:
transmit, to the first network function device, the indication of the UDM group identifier and the UDR group identifier along with a charging function (CHF) group identifier associated with the user profile.

14. The NRF network function of claim 13, wherein the one or more processors, to transmit the indication of the UDM group identifier and the UDR group identifier, are configured to:
transmit, to the first network function device, a subscriber profile associated with the user profile,
wherein the indication of the CHF group identifier is included in the subscriber profile.

15. A non-transitory computer-readable medium storing a set of instructions, the set of instructions comprising:
one or more instructions that, when executed by one or more processors of a first network function device, cause the first network function device to:
receive, from a second network function device, at least one of:
an indication of a unified data management (UDM) group identifier associated with a UDM device, and
an indication of a user data repository (UDR) group identifier associated with a UDR device that is associated with the UDM device; and
transmit, to a network repository function (NRF) device, at least one of:
a request for discovery of the UDM device based on the UDM group identifier, or
a request for discovery of the UDR device based on the UDR group identifier.

16. The non-transitory computer-readable medium of claim 15, wherein the first network function device comprises an access and mobility management function (AMF) device;
wherein the one or more instructions, that cause the first network function device to receive the at least one of the indication of the UDM group identifier or the indication of the UDR group identifier, cause the first network function device to:
receive the indication of the UDM group identifier and the indication of the UDR group identifier; and
wherein the one or more instructions, that cause the first network function device to transmit the at least one of the request for discovery of the UDM device or the request for discovery of the UDR device, cause the first network function device to:
transmit the request for discovery of the UDM device.

17. The non-transitory computer-readable medium of claim 16, wherein the one or more instructions, when executed by the one or more processors, further cause the first network function device to:
transmit the at least one of the indication of the UDM group identifier or the indication of the UDR group identifier to at least one of a policy control function (PCF) device or a session management function (SMF) device.

18. The non-transitory computer-readable medium of claim 15, wherein the first network function device comprises a policy control function (PCF) device;
wherein the one or more instructions, that cause the first network function device to receive the at least one of the indication of the UDM group identifier or the indication of the UDR group identifier, cause the first network function device to:
receive the indication of the UDM group identifier; and
wherein the one or more instructions, that cause the first network function device to transmit the at least one of the request for discovery of the UDM device or the request for discovery of the UDR device, cause the first network function device to:
transmit the request for discovery of the UDR device.

19. The non-transitory computer-readable medium of claim 15, wherein the first network function device comprises a session management function (SMF) device;
wherein the one or more instructions, that cause the first network function device to receive the at least one of the indication of the UDM group identifier or the indication of the UDR group identifier, cause the first network function device to:
receive the indication of the UDM group identifier and the indication of the UDR group identifier; and
wherein the one or more instructions, that cause the first network function device to transmit the at least one of the request for discovery of the UDM device or the request for discovery of the UDR device, cause the first network function device to:
transmit the request for discovery of the UDM device.

20. The non-transitory computer-readable medium of claim 19, wherein the one or more instructions, when executed by the one or more processors, further cause the first network function device to:
transmit the indication of the UDR group identifier to a policy control function (PCF) device.
